(19) United States
(12) Patent Application Publication
(10) Pub. No.: US 2011/0132470 A1
(43) Pub. Date: Jun. 9, 2011

(54) FLOOR DRAIN FOR A SANITARY INSTALLATION AND METHOD FOR INSTALLING SUCH A FLOOR DRAIN

(75) Inventors: Patrick SCHNYDER, Menzingen (CH); Maarten Roest, Jona (CH); Peter Reichmuth, Eschenbach (CH); Samuel Müller, Ruti (CH)

(73) Assignee: Geberit International AG, Jona (CH)

(21) Appl. No.: 12/961,257

(22) Filed: Dec. 6, 2010

(30) Foreign Application Priority Data
Dec. 7, 2009 (EP) 09 405 213.1
Dec. 19, 2009 (DE) 20 2009 017 155.8

(51) Int. Cl. F16L 5/00; B23P 17/04

(52) U.S. Cl. 137/360; 29/428

(57) ABSTRACT

The floor drain possesses an inlet housing (11), which has an opening for floor water to be led away and which is connectable to a wall drain opening of a vertical wall. On the inlet housing (11) are arranged connecting means (44), which are adjustable with respect to the vertical wall and with which the inlet housing (11) can be connected in a sealtight manner to the vertical wall. The connecting means (44) are preferably adjustable in depth and/or height. They have at least one sealing foil (24), with which the connecting means (44) can be sealed against a floor (6) and/or a panelling (14).

The invention relates to a floor drain for a sanitary installation, having an inlet housing, which has an opening for floor water to be led away and which is connectable to a wall drain opening of a vertical wall.

Such a floor drain has been disclosed in the prior art by EP-A-2 009 187 of the Applicant. This floor drain is intended for a shower. The floor drain can be fully built into a wall, for example in a front wall or building wall. With such a drain, a shower tray or a drain cover in the floor can be avoided. This allows a shower manufacture which is particularly suitable for the disabled. The water is led off through a relatively narrow slit at the lower end of the wall. Yet the drain is also suitable, for example, for the drainage of floor water in a kitchen or another room. The inlet housing collects the floor water to be led away and conducts this into a drain pot which is disposed in the vertical wall and on which the inlet housing is mounted in a sealtight manner.

The installation of such a floor drain requires a very large number of work steps, which must be carried out, moreover, by different skilled workers. In particular, an installer for erecting the assembly stand, a mason, a plumber and, generally, a tiler, are necessary. The sealing jobs, in particular, are complex.

The object of the invention is to provide a floor drain of the said type which is easier to install.

In the case of the floor drain of the generic type, the object is achieved by virtue of the fact that on the inlet housing are arranged connecting means, which are adjustable and with which the inlet housing can be connected in a sealtight manner to the wall drain opening. The connecting means are, in particular, depth-adjustable and/or height-adjustable and can be adjusted, for example, with respect to a panelling of the vertical wall. In a floor drain according to the invention, the inlet housing can be sealed against the vertical wall more easily and more securely than previously, since the connecting means are adjustable, for example, with respect to a panelling or a floor construction.

According to one refinement of the invention, the connecting means have a depth-adjustable frame. This frame can be adjusted, for example, with respect to a panelling of the vertical wall. According to one refinement of the invention, the adjustment of the frame or of the connecting means is realized with at least one adjusting screw. This allows a particularly simple and precise adjustment of the connecting means with respect to the vertical wall.

According to one refinement of the invention, it is provided that the frame is adjustably connected to the inlet housing. The frame is thus adjusted relative to the inlet housing.

The sealing is particularly simple and secure if, according to one refinement of the invention, the connecting means have at least one sealing foil, with which the connecting means can be sealed with respect to a floor wall and/or with respect to the said vertical wall. Once the connecting means are adjusted with respect to the vertical wall, then the sealing foil is likewise exactly positioned in relation to the vertical wall and allows a simple and secure sealing. The sealing foil is, for example, a flexible film, which is applied to the connecting means, for example to the said frame, and which can be stuck onto a floor construction.

According to one refinement of the invention, it is provided that the connecting means have an opening, which is covered with a removable construction guard. This construction guard possesses, as an aid to the creation of a floor construction, a levelling edge. This allows a particularly precise positioning of the floor drain with respect to the building floor.

According to one refinement of the invention, it is provided that the connecting means have a subframe, which is adjustable in height. The adjustability of the subframe allows, in particular, the exact adjustment of a cover which is fastened to an ornamental frame. This ornamental frame is fastened to the subframe.

According to one refinement of the invention, the invention comprises a floor drain which has a depth-adjustable frame, on this a subframe, and on the subframe an ornamental frame to which a cover is fastened. The cover is preferably detachably fastened to the ornamental frame. Once the cover frame is removed, the drain pot is accessible from outside and is able to be inspected or cleaned.

The invention additionally relates to a method for installing a floor drain. Here too, the adjustment of the connecting means with respect to the vertical wall, for example the front side of a panelling, is crucial. The adjustment is realized, in particular, such that the connecting means, with a front side, lie flush with a front side of the panelling.

Further advantageous features derive from the dependent patent claims, the following description and the drawing.

An illustrative embodiment of the invention is explained in greater detail below with reference to the drawing, wherein:

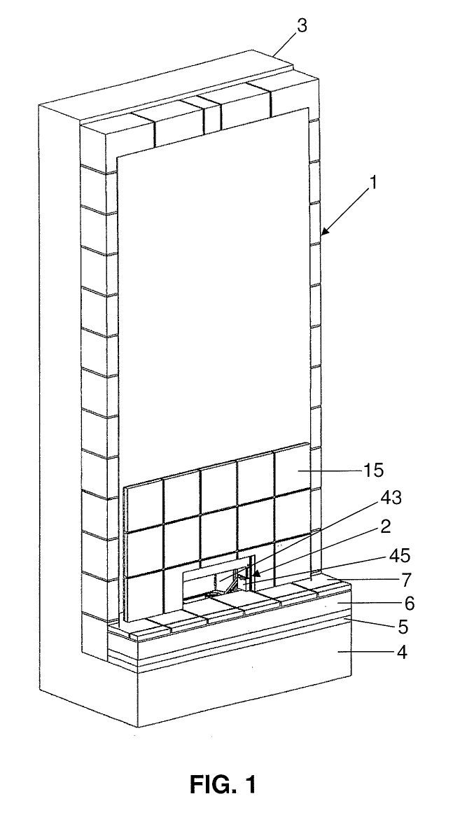

FIG. 1 shows a three-dimensional view of a sanitary installation having a floor drain according to the invention,

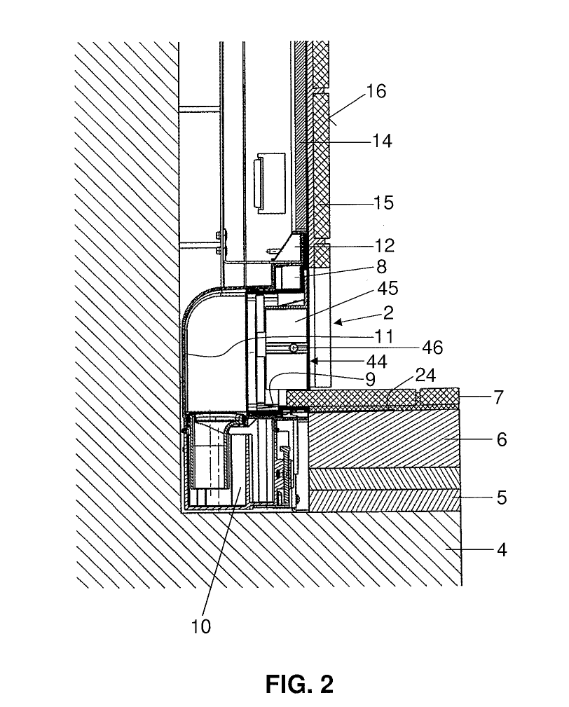

FIG. 2 shows a vertical section through a part of the sanitary installation,

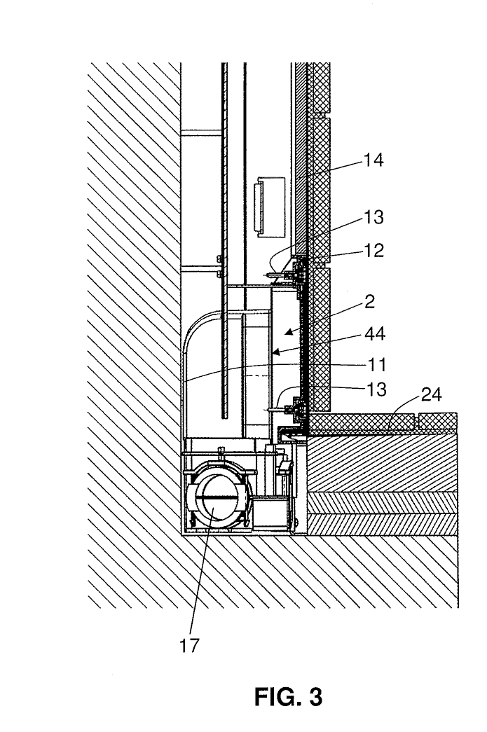

FIG. 3 shows a further vertical section through the sanitary installation,

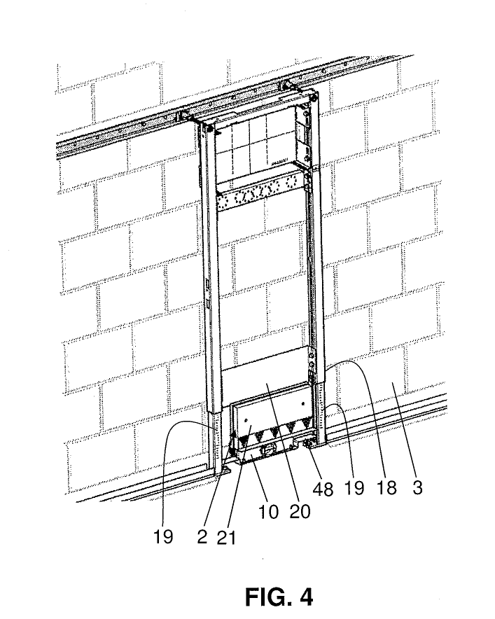

FIG. 4 shows a three-dimensional view of a building wall with an assembly stand and a floor drain fastened thereto,

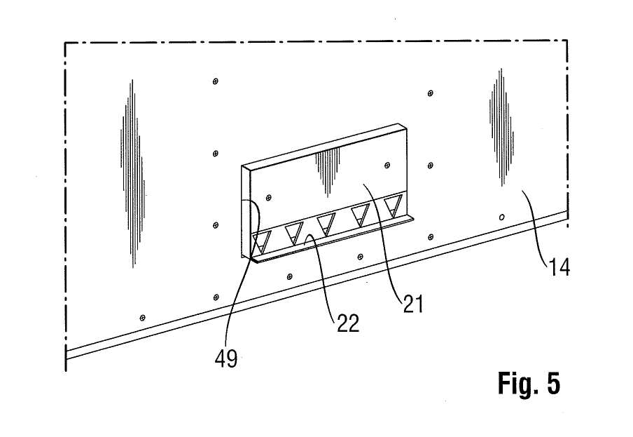

FIG. 5 shows a partial view of the sanitary installation following the creation of a panelling,

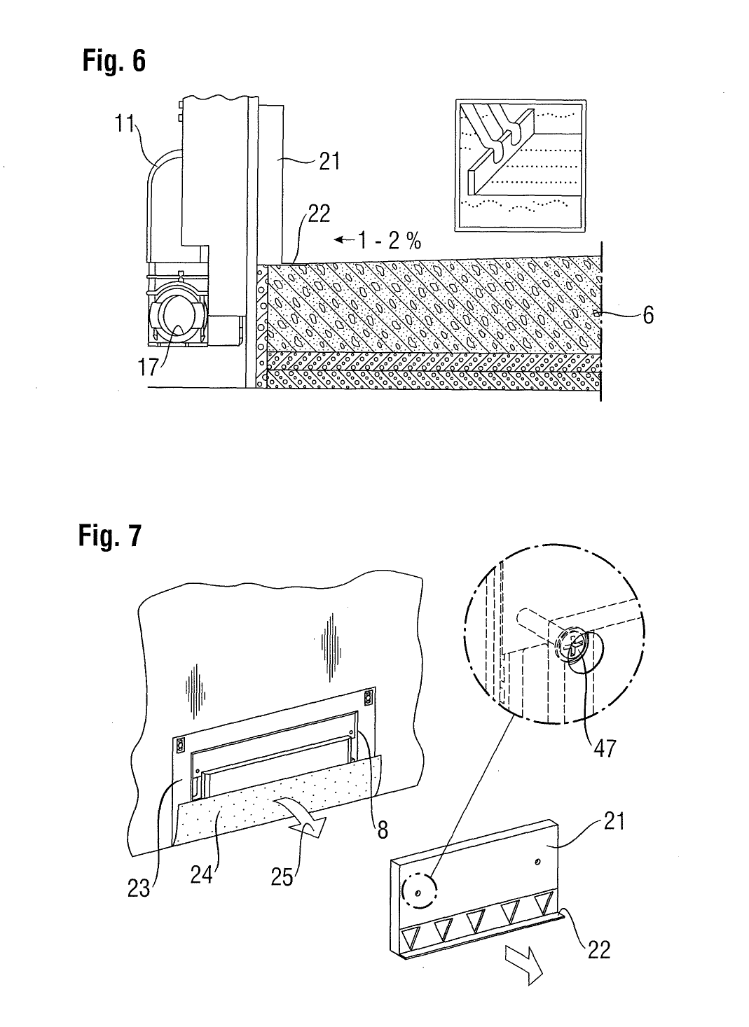

FIG. 6 shows a part-section through the sanitary installation following the creation of the floor construction,

FIG. 7 shows a schematic representation in illustration of an assembly step,

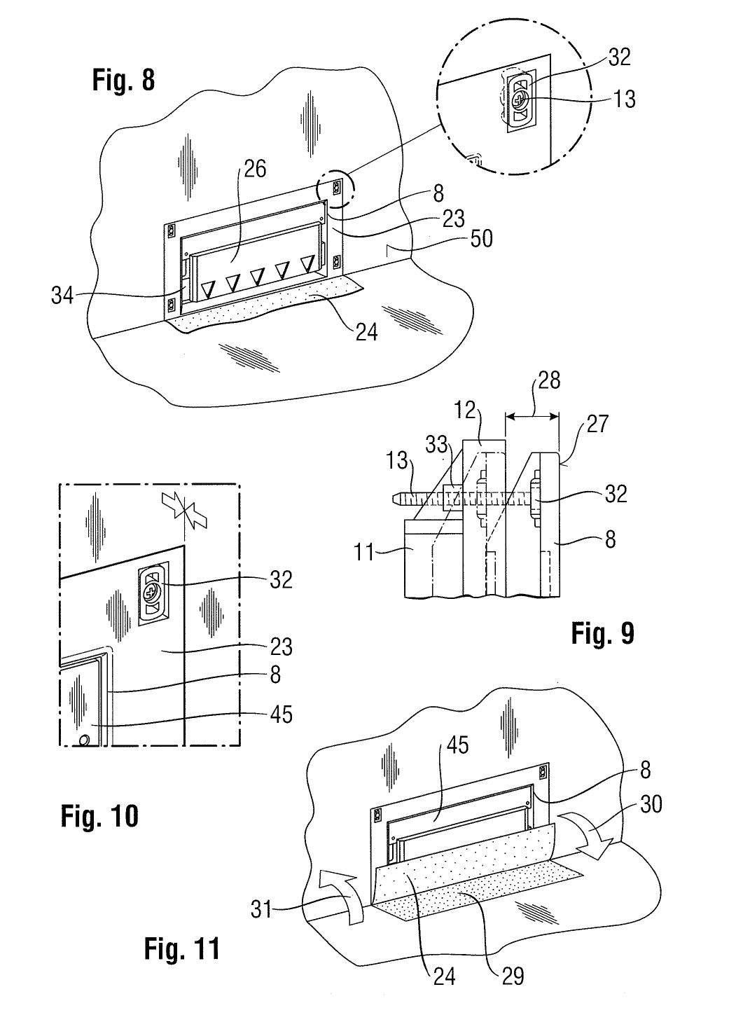

FIG. 8 shows a schematic representation in illustration of the adjustability of the connecting means,

FIG. 9 shows schematically a side view of a part of the inlet housing and of the connecting means, as well as of the depth-adjusting facility,

FIG. 10 shows a schematic view in illustration of the adjustment with respect to the flushness of a front side of the panelling,

FIG. 11 shows schematically the sealing of the connecting means with respect to the floor construction,

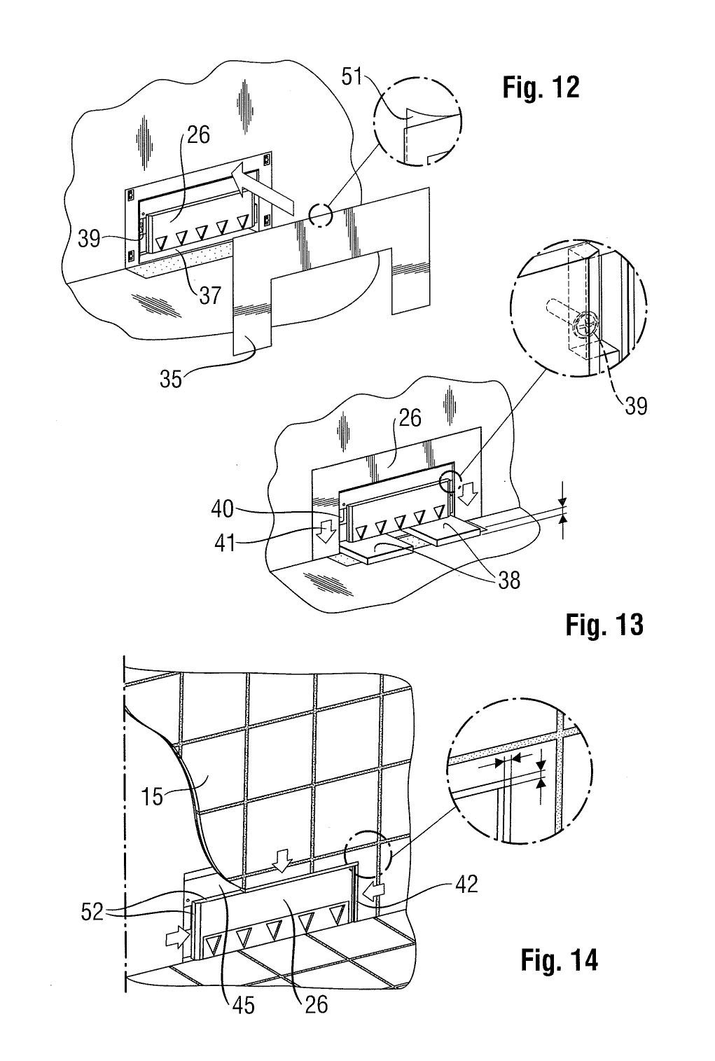

FIG. 12 shows a schematic representation in illustration of a step for sealing of the floor drain,

FIG. 13 shows a schematic representation in illustration of the height-adjustability of the subframe,

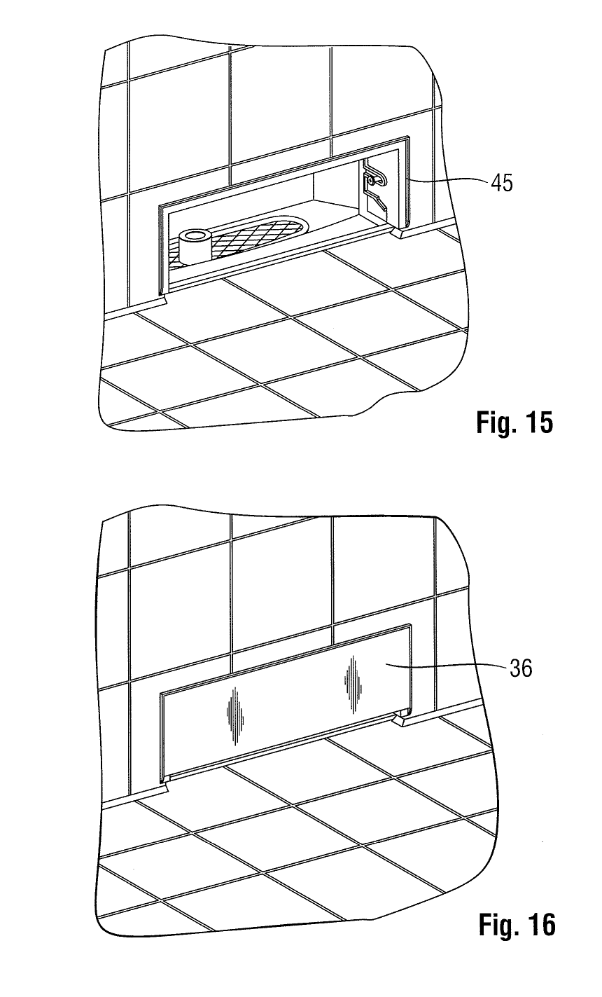

FIG. 14 shows a schematic view in illustration of a concluding assembly step, and

FIGS. 15/16 show views comprising ornamental frame and cover plate.

FIG. 1 shows a sanitary installation 1, for example for a shower, which is fastened to a building wall 3 and is deposited on a floor construction 6. The floor construction 6 is insulated against a building floor 4 with an insulation layer 5. The floor construction 6 is covered with tiles 7. The building wall 3 is likewise provided with tiles 15, which surround a wall drain opening 43 behind which the floor drain 2 according to the invention is disposed. Through this opening 43, floor water can be led off into a drain pot (not shown here) disposed behind the opening 43. The opening 43 is generally covered, with the exception of a lower gap, by a cover plate 36 (not shown here) (FIG. 15). This cover plate 36 can be removed for cleaning or inspection of the drain pot. The floor drain 2 is in this case intended for a shower, though other applications in domestic installation, for example in a kitchen, are here also conceivable.

As shown, in particular, by FIGS. 2 and 3, the floor drain 2 has an inlet housing 11 having a drain pot 10. This drain pot 10, which is known per se, forms a siphon and an outlet opening 17, which is connectable to a waste disposal line (not shown here). The inlet housing 11 serves to collect floor water and divert it into the drain pot 10. A housing collar 12 forms a vertical opening, which is sealed against the floor construction 6 and against a panelling 14.

In order to seal the inlet housing 11 against the floor construction 6 and against the vertical building wall 3, connecting means 44 are provided, which on the inlet side are disposed on the inlet housing and are connected thereto.

The connecting means 44 have a frame 8, which according to FIGS. 8 and 9 is connected with adjusting screws 13 adjustably to the inlet housing 11. As FIG. 8 shows, four such adjusting screws 13 are provided. These are respectively mounted on a head in a bearing part 32 of the frame 8, as shown by FIGS. 8 to 10. With a front end, the adjusting screws 13 respectively engage in a holder 33 of the housing collar 12. By turning the adjusting screws 13, it is possible to adjust the distance of a front side 27 of the frame 8 with respect to the inlet housing 11, as indicated in FIG. 9 with the double arrow 28. In place of adjusting screws 13, other means by which an adjustment of the frame 8 with respect to the inlet housing 11 is possible are here also conceivable however. Fastened to the frame 8, at a bottom margin, is a sealing foil 24, which serves to connect the frame 8 in a sealtight manner to the floor construction 6. The sealing foil 24 extends in a region 23 (FIG. 7) vertically upwards and covers with this region the front side of the frame 8. Close to the adjusting screws 13, the region 23 is excluded.

Inserted in the frame 8 is a subframe 34, which is height-adjustable with respect to the frame 8. To this end, the subframe 34 according to FIG. 13 possesses two mutually spaced slots 40, which are respectively passed through by an adjusting screw 39. These adjusting screws 39 are screwed into threaded bores (not shown here) of the frame 8.

In addition, an ornamental frame 45 is provided, which is fastened to the subframe 34.

The fastening is realized according to FIG. 2 with clamping screws 46. The ornamental frame 45 is preferably adjustable in depth with respect to the subframe 34. Finally, the ornamental frame 45 serves for the fastening of the cover plate 36.

The installation of the floor drain 2 is explained in greater detail below.

First of all, the assembly stand 18 shown in FIG. 4 is erected in front of the building wall 3. The assembly stand 18 possesses two mutually spaced uprights 19, which are connected to an upper plate-like cross member 20 and a lower cross member 48. The floor drain 2, with the inlet housing 11 and the drain pot 10, is fastened to the assembly stand 18. The opening of the floor drain 2 is covered with the construction guard 21. Once the floor drain 2 is installed, then the panelling 14 is attached thereto. In this panelling 14, a cutout 49 is provided for the construction guard 21. The panelling 14 extends downwards to the building floor 4, which forms the so-called rough floor. An insulation layer 5, or even a plurality of such layers, as well as the floor construction 6, are now applied to the building floor 4. In order that this floor construction 6 is aligned precisely with respect to the floor drain 2, the construction guard 21 has on a bottom edge a levelling edge 22, which can be configured, for example, as metal strips. According to FIG. 6, the not yet hardened floor construction 6 is levelled, from the levelling edge 22.

Once the floor construction 6 is hardened, then, according to FIG. 7, the construction guard 21 is removed by unscrewing of the screws 47. The upwardly bent-over sealing foil is thereby released and this is now laid down onto the floor construction 6 according to the arrow 25. The depth of the frame 8 is now adjusted with respect to the front side 50 of the panelling 14, according to FIGS. 8 to 10. This is done by turning of the adjusting screws 13. The frame 8 is adjusted to the point where the front side of the frame 8 lies flush with the front side 50 of the panelling 14. In FIG. 9, the frame 8 is thus adjusted in depth according to the double arrow 28. Once the front side 27 lies flush with the front side 50, according to FIG. 10, then the desired position of the frame 8 is attained.

In a next step, the sealing foil 24, according to FIG. 11, is now turned upwards according to the arrow 31 and a sticker 29 is applied to the floor construction 6. By turning down the sealing foil 24 and pressing on it, the sealing foil 24 is now stuck to the floor construction 6.

As the next step, according to FIG. 12, a rear elevation of the roughly U-shaped sealing foil 35 is stuck onto the front side 50 of the panelling 14 and onto the likewise U-shaped region 23 of the frame 8. This sealing foil 35 thus seals the frame 8 against the panelling 14. The sealing foil 35 can be self-adhesive, a protective film 51 being previously peeled off. The floor drain 2 is now connected in a sealtight manner to the floor construction 6 and the panelling 14.

The next step is now the creation of the floor covering 7 by application of the tiles 38. These tiles 38 can be very varied in thickness. In order to adjust the cover plate 36 at its bottom edge precisely in relation to the provided floor covering 7, the subframe 34 is adjusted in height according to the arrow 41 of FIG. 13, with the construction guard 26. To this end, the adjusting screws are unscrewed. Once the subframe 34, and thus the cover plate 36, is properly positioned, then the adjusting screws 39 are retightened. The tiles 38 are now applied until the whole of the floor construction 6 is provided with the desired floor covering 7.

In a next step, relatively narrow strips 42 are stuck onto the top and side margins 52 of the construction guard 26. These strips 42 predetermine the intended distance of the ornamental frame 45 from the tiles 15. The panelling 14 is now covered, around the construction guard 26, with the tiles 15. Below the bottom margin of the cover plate 36, water can run off into the inlet housing 11 through the, for example, gap-shaped opening. Following the removal of the construction guard 26, the ornamental frame 45 is inserted, as shown in FIG. 15. The cover plate 36 can be fastened per se in any chosen manner to the ornamental frame 45. For example, the cover plate 36 can be fastened pivotably to the ornamental frame. For the cleaning and inspection of the drain pot 10, the cover plate 36 can then be turned up.

### REFERENCE SYMBOL LIST

1 sanitary installation
2 floor drain
3 building wall
4 building floor (rough floor)
5 insulation layer
6 floor construction
7 floor covering
8 frame
9 drain opening
10 drain pot
11 inlet housing
12 housing collar
13 adjusting screw
14 panelling
15 tiles
16 front side
17 outlet opening
18 assembly stand
19 upright
20 cross member
21 construction guard
22 levelling edge
23 region
24 sealing foil
25 arrow
26 construction guard
27 front side
28 double arrow
29 sticker
30 arrow
31 arrow
32 bearing part
33 holder
34 subframe
35 sealing foil
36 cover plate
37 gap
38 tile
39 adjusting screw
40 slot
41 arrow
42 strip
43 wall drain opening
44 connecting means
45 ornamental frame
46 clamping screw
47 fastening screw
48 lower cross member
49 cutout
50 front side
51 protective film
52 margin

1.-15. (canceled)

16. A floor drain for a sanitary installation, comprising an inlet housing, which has an opening for floor water to be led away and which is connectable to a wall drain opening of a vertical wall, wherein on the inlet housing are arranged connecting means, which are adjustable and with which the inlet housing can be connected to the vertical wall.

17. A floor drain according to claim 16, wherein the connecting means have a depth-adjustable frame.

18. A floor drain according to claim 16, wherein the connecting means are adjustable by means of at least one adjusting screw.

19. A floor drain according to claim 18, wherein the at least one adjusting screw engages in the inlet housing.

20. A floor drain according to claim 16, wherein the connecting means are connected to the inlet housing and are adjustable with respect thereto.

21. A floor drain according to claim 17, wherein the frame is a panelling frame.

22. A floor drain according to claim 16, wherein the connecting means have at least one sealing foil, with which they can be sealed against a floor.

23. A floor drain according to claim 17, wherein the connecting means have an opening, which is covered with a removable construction guard.

24. A floor drain according to claim 23, wherein the construction guard has, as an aid to the creation of a floor construction, a levelling edge.

25. A floor drain according to claim 16, wherein the connecting means have a height-adjustable subframe.

26. A floor drain according to claim 16, wherein the connecting means have an ornamental frame.

27. A floor drain according to claim 26, wherein a cover plate is fastened to the ornamental frame.

28. A floor drain according to claim 25, wherein the ornamental frame is fastened to the subframe.

29. A method for installing a floor drain according to claim 16, wherein the following assembly steps:
a) erection of an assembly stand,
b) fastening of the floor drain over the rough floor,
c) creation of a panelling,
d) creation of a floor construction,
e) adjustment of the connecting means,
f) sealing of the connecting means.

30. A method according to claim 29, wherein the connecting means are adjusted in depth, for example with respect to a panelling, and/or in height, for example with respect to a floor.
